(19) United States
(12) Patent Application Publication
(10) Pub. No.: US 2020/0277503 A1
(43) Pub. Date: Sep. 3, 2020

(54) RESINS FOR PRODUCING BLACK COLORED OBJECTS BY STEREOLITHOGRAPHY

(71) Applicant: Carbon, Inc., Redwood City, CA (US)

(72) Inventors: Yuyang Du, Parlin, NJ (US); Bob E. Feller, San Mateo, CA (US)

(21) Appl. No.: 16/787,081

(22) Filed: Feb. 11, 2020

Related U.S. Application Data
(60) Provisional application No. 62/811,615, filed on Feb. 28, 2019.

(51) Int. Cl. C09D 7/41; C09D 175/04; B33Y 10/00; B33Y 70/00

(52) U.S. Cl. CPC C09D 7/41; C09D 175/04; C08K 5/16; B33Y 70/00; B33Y 10/00

(57) ABSTRACT

The present invention provides a stereolithography resin useful for producing black-colored objects, the resin comprising: (a) an unpigmented base stereolithography resin; and (b) a pigment blend, the pigment blend consisting essentially of: (i) a CMY blend; and (ii) black pigment. Methods of making a black-colored object and objects so produced are also provided.

### RELATED APPLICATIONS

The present application claims priority to U.S. Provisional Application Ser. No. 62/811,615, filed Feb. 28, 2019, the disclosure of which is hereby incorporated by reference in its entirety.

### FIELD OF THE INVENTION

The present invention concerns resins for stereolithography, methods of using the same, and products produced from such resins.

### BACKGROUND OF THE INVENTION

A group of additive manufacturing techniques sometimes referred to as “stereolithography” creates a three-dimensional object by the sequential polymerization of a light polymerizable resin. Such techniques may be “bottom-up” techniques, where light is projected into the resin on the bottom of an object growing on a build platform above a light transmissive window, or “top-down” techniques, where light is projected onto the resin on top of the growing object, which is then immersed downward into the pool of resin.

The introduction of more rapid stereolithography techniques sometimes referred to as continuous liquid interface production (CLIP), coupled with the introduction of “dual cure” resins for additive manufacturing, has expanded the usefulness of stereolithography from prototyping to manufacturing (see, e.g., U.S. Pat. Nos. 9,211,678; 9,205,601; and U.S. Pat. No. 9,216,546 to DeSimone et al.; J. Tumbleston et al., Continuous liquid interface production of 3D Objects, Science 347, 1349-1352 (2015); Rolland et al., U.S. Pat. Nos. 9,676,963, 9,453,142 and 9,598,606). For such purposes, bottom-up stereolithography is preferred, as the pool of resin (sometimes provided on a “window cassette”) can be shallow and hence smaller in volume.

In stereolithography methods such as CLIP, UV light must pass through a resin and activate a photoinitiator for polymerization of successive regions of the growing three-dimensional object to occur. When colored objects are to be produced, some pigments can inhibit the passage of light and limit the activation of photoinitiator, resulting in defects of printed objects or a slower process. This can be a particular problem when relatively dark objects, such as those appearing black when viewed, are to be produced. Accordingly, new approaches for the production of black-colored objects by additive manufacturing are needed.

### SUMMARY OF THE INVENTION

The present invention provides a stereolithography resin useful for producing black-colored objects, the resin comprising: (a) an unpigmented base stereolithography resin (for example, resins having a composition such as described herein); and (b) a pigment blend, the pigment blend consisting essentially of: (1) a CMY blend consisting essentially of cyan (C), magenta (M), and yellow (Y) pigment; and (ii; black pigment included in an amount by weight equal to 20 or 25 percent to 75 or 80 percent that of the CMY blend.

While CMY pigment combinations are known for use in creating black colored print in inkjet printing, alone and in combination with reduced amounts of black (K) pigment (see, e.g., U.S. Pat. No. 7,404,849 to Jackson et al.), they have not been suggested for use when the material carrying them further contains a photoinitiator for the production of a three-dimensional object, and have not been suggested for use in bottom-up stereolithography systems where the polymerization light must first pass through a layer of unpolymerized resin functioning as a release layer (or the like) before reaching an area where the photoinitiator is activated and polymerization can occur.

The resins and methods are useful for making a variety of black-colored objects by stereolithography, including objects comprised of an open lattice (that is, a set of interconnected struts) in at least a portion thereof. The resins and methods may promote the activation of photoinitiator during the stereolithography (e.g., CLIP), resulting in reduced defects of printed objects and/or a more rapid process.

### BRIEF DESCRIPTION OF THE DRAWINGS

FIG. 1 schematically illustrates a process in accordance with the present invention, in which light (dashed lines) from a light source (11) for polymerizing the object (23) attached to a carrier platform (13) must pass through a window (12) and a sustained liquid interface (21) before reaching a polymerization region (22).

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art. As used herein, the term “and/or” includes any and all possible combinations or one or more of the associated listed items, as well as the lack of combinations when interpreted in the alternative (“or”). The disclosures of all United States patent references cited herein are to be incorporated by reference herein in their entirety.

The transitional phrase “consisting essentially of” means that the scope of a claim is to be interpreted to encompass the specified materials or steps recited, and also additional materials or steps that do not materially affect the basic and novel characteristics of the claimed invention as described herein. For example, in some embodiments of the resins, the pigment blend consisting essentially of particular pigments and/or ratios thereof does not include (or does not appreciably include) additional pigments that may modify the properties of this component.

### 1. Pigmented Resins and Resin Formulations

Resins for additive manufacturing that may be used as an unpigmented base stereolithography resin are known and described in, for example, DeSimone et al., U.S. Pat. Nos. 9,211,678; 9,205,601; and 9,216,546. In addition, dual cure resins for additive manufacturing are known and described in, for example, Rolland et al., U.S. Pat. Nos. 9,676,963; 9,598,606; and 9,453,142. Non-limiting examples of dual cure resins include, but are not limited to, resins for producing objects comprised of polymers such as polyurethane, polyurea, and copolymers thereof; objects comprised of epoxy; objects comprised of cyanate ester; objects comprised of silicone; etc.

As noted above, the present invention provides a stereolithography resin useful for producing black-colored objects, comprising: (a) from 97 to 99.9 percent by weight of an unpigmented base stereolithography resin (for example, resins having a composition such as described above); and (b) from 0.1 to 3 percent by weight of pigment blend, the pigment blend consisting essentially of: (i) a CMY blend consisting essentially of cyan, magenta, and yellow pigment in a mass ratio of 1 part cyan to 7-9 parts magenta to 2-6 parts yellow; and (ii) black pigment included in an amount by weight equal to 20 or 25 percent to 75 or 80 percent that of the CMY blend.

In some embodiments; the black pigment is included in an amount by weight of from 20 or 25 percent to 49 or 50 percent that of the CMY blend. In other embodiments, the black pigment is included in an amount by weight of from 50 or 51 percent to 75 or 80 percent that of the CMY blend.

In some embodiments, the resin includes a photo initiator having an absorption peak in the ultraviolet light region.

In some embodiments, the resin comprises a dual cure resin, such as a dual cure resin for producing an object comprising polyurethane, polyurea, or a copolymers thereof; epoxy; cyanate ester; silicone; etc.

### 2. Apparatus and Methods

Suitable additive manufacturing apparatus include those configured for carrying out bottom-up additive manufacturing. Such methods are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al. The disclosures of these patents and applications are incorporated by reference herein in their entirety.

In some embodiments, the additive manufacturing step is carried out by one of the family of methods sometimes referred to as continuous liquid interface production (CLIP). CLIP is known and described in, for example, U.S. Pat. Nos. 9,211,678; 9,205,601; 9,216,546; and others; in J. Tumbleston et al., Continuous liquid interface production of 3D Objects, Science 347, 1349-1352 (2015); and in R. Janusziewcz et al., Layerless fabrication with continuous liquid interface production, Proc. Natl. Acad. Sci. USA 113, 11703-11708 (2016). Other examples of methods and apparatus for carrying out particular embodiments of CLIP, or of additive manufacturing, include but are not limited to those described in B. Feller, US Patent App. Pub. No. US 2018/0243976 (published Aug. 30, 2018); M. Panzer and J. Tumbleston, US Patent App Pub. No. US 2018/0126630 (published May 10, 2018); K. Willis and B. Adzima, US Patent App Pub. No. US 2018/0290374 (Oct. 11, 2018); Batchelder et al., US Patent App Pub. No. US 2017/0129169; Sun and Lichkus, US Patent App Pub. No. US 2016/0288376; Willis et al., US Patent App Pub. No. US 2015/0360419; Lin et al., US Patent App Pub. No. US 2015/0331402; and D. Castanon, US Patent App Pub. No. US 2017/0129167, the disclosures of which are incorporated by reference herein in their entirety.

A black-colored object can be made by exposing a resin as described above to temporally and spatially patterned light in a bottom-up or top-down stereolithography apparatus until the object is produced.

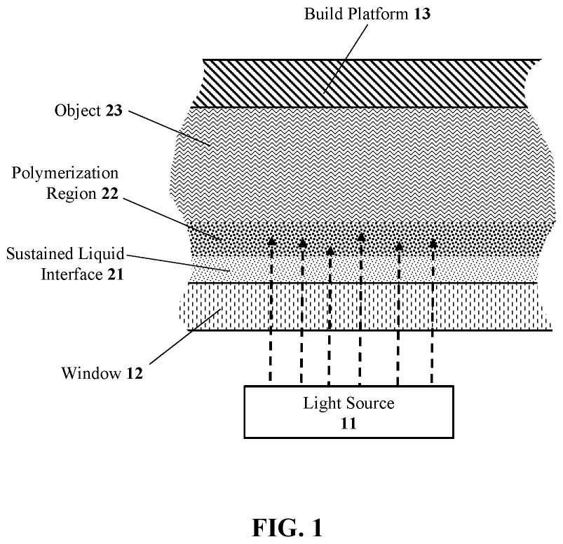

With reference to the schematic shown in FIG. 1, in some embodiments, the method comprises: (a) providing an additive manufacturing apparatus including a build platform (13) and a light transmissive window (12), the build platform (13) and the window (12) defining a build region therebetween, with the window (12) carrying a resin as described above; (b) advancing the build platform (13) and the window (12) towards one another until the build platform contacts the resin; and (c) producing a black-colored object (23) by exposing a polymerization region (22) of the resin to patterned light (e.g., ultraviolet light) from a light source (11) through the window (12) and advancing the window (12) and the build platform (13) away from one another while maintaining a sustained liquid interface (21) of unpolymerized resin between the object (23) and the window (12). The sustained liquid interface (21) can be maintained by any suitable technique, including but not limited to passing an inhibitor of polymerization (such as oxygen) through the window (e.g., a semipermeable window) (12) and into the sustained liquid interface (21), by exposing the sustained liquid interface (21) to light at a second wavelength that inhibits polymerization thereof, etc., including combinations thereof.

The present invention is explained in greater detail in the following non-limiting Examples.

### Example 1

### Preparation of CMY and CMYK Pigment Combinations

SPECTRARAY® cyan pigment was received from Sun Chemical Corporation (Parsippany, N.J.). HOSTATINT™ PINK A-EB 100 magenta pigment, HOSTATINT™ YELLOW A-H3G 100 yellow pigment, and HOSTATINT™ A-N 100 black pigment were received from Clariant International Ltd (Muttenz, Switzerland). Cyan, magenta, and yellow colorants were mixed for 10 minutes using a THINKY™ mixer. A preferred CMY combination matching black was comprised of cyan, magenta, and yellow colorants at mass ratios varying from 1:8:3 to 1:8:5. In addition, the black pigment was added to the CMY mixture at weight percentages from 25% to 75%, resulting in a CMYK mixture black in color at a reduced black pigment loading.

### Example 2

### Resin Formulations

To prepare a dual cure resin useful for producing an elastomeric lattice structure based on the polyurethane chemistry, the following components were mixed for 30 min in a THINKY™ mixer:

A. 60 g of (meth)acrylate blocked polyurethane (ABPU);
B. 20 g of lauryl methacrylate (LMA);
C. 10 g of di(ethylene glycol) methyl ether methacrylate (DEGMA);
D. 1 g of isoboronyl methacrylate (IBOMA);
E. 0.9 g of diphenyl(2,4,6-trimethylbenoyl) phosphine oxide (TPO).

The ABPU was prepared from tertiary-butylaminoethyl methacrylate (TBAEMA), poly(tetramethylene) glycol (PTMO), and isophorone diisocyanate (IPDI), in accordance with known techniques, such as described in U.S. Pat. No. 9,453,142 to Rolland et al. (incorporated by reference herein).

The CMYK combination (shown separately as the CMY pigment combination and the black pigment in Table 1 below) was added to the mixture and mixed, followed by the addition of the curative, 4,4′-methylenebis(2-methylcyclohexylamine) (MACM). The resulting resin formulation was black, semi-transparent at low colorant concentrations (for example, lower than 0.1 wt. %), and opaque at high colorant concentrations (for example, above 1 wt. %). The formulation composition is shown in Table 1 below, and the formulation composition of a control resin (black pigment only) is shown in Table 2 below.

Three-dimensional objects are fabricated by additive manufacturing process, preferably by stereolithography method and especially by continuous liquid interface production (CLIP). Printed objects are wiped or cleaned with organic solvents, followed by thermal curing by heating.

TABLE 1
Formulation with CMYK mixture (Formulation A)

| Component | Parts by weight |
|---|---|
| ABPU | 60 |
| LMA | 20 |
| DEGMA | 10 |
| IBOMA | 1 |
| TPO | 0.9 |
| CMY combination | 0.05 |
| Black pigment | 0.05 |
| MACM | 8 |

TABLE 2
Formulation with a black pigment (Control)

| Component | Parts by weight |
|---|---|
| ABPU (TB + PTMO + IPDI) | 60 |
| LMA | 20 |
| DEGMA | 10 |
| IBOMA | 1 |
| TPO | 0.9 |
| Black | 0.1 |
| MACM | 8 |

### Example 3

### Production of Objects

Three-dimensional objects were fabricated on a Carbon Inc. M1 printer (Redwood City, Calif.) by continuous liquid interface production (CLIP). Printed objects were wiped or cleaned with organic solvents, followed by thermal curing by heating, in accordance with known techniques. UV curing profiles of formulation A and control were measured. UV exposure conditions were 9 mW/cm², 3.5 s, and 200 μm slicing. The green modulus of the objects (tensile modulus after printing) was measured on a RSA-G2 solid analyzer. Table 3 describes differences in results, comparing Formulation A with control.

TABLE 3
UV curing characteristics of formulations
and visual appearance of printed objects.

| | Formulation A | Control |
|---|---|---|
| Curing dosage | 5 | 5.5 |
| Absorption at 385 | 0.0014 | 0.0018 |
| nm | | |
| Green modulus | 2.3 | 1.3 |
| (MPa) | | |
| Printed part | Open lattice structure, | Open lattice structure, |
| | black colored appearance | black colored appearance |
| | on visual inspection; | on visual inspection; |
| | thin regions slightly | thin regions slightly |
| | translucent when back-lit | translucent when back-lit |

The foregoing is illustrative of the present invention, and is not to be construed as limiting thereof. The invention is defined by the following claims, with equivalents of the claims to be included therein.

We claim:

1. A stereolithography resin useful for producing black-colored objects, comprising:
(a) from 97 to 99.9 percent by weight of an unpigmented base stereolithography resin; and
(b) from 0.1 to 3 percent by weight of pigment blend, said pigment blend consisting essentially of:
(i) a CMY blend consisting essentially of cyan, magenta, and yellow pigment in a mass ratio of 1 part cyan to 7-9 parts magenta to 2-6 parts yellow; and
(ii) black pigment included in an amount by weight equal to 20 or 25 percent to 75 or 80 percent that of said CMY blend.

2. The resin of claim 1, wherein said black pigment is included in an amount by weight of from 20 or 25 percent to 49 or 50 percent that of said CMY blend.

3. The resin of claim 1, wherein said black pigment is included in an amount by weight of from 50 or 51 percent to 75 or 80 percent that of said CMY blend.

4. The resin of claim 1, wherein said resin includes a photoinitiator having an absorption peak in the ultraviolet light region.

5. The resin of claim 1, wherein said resin comprises a dual cure resin.

6. The resin of claim 1, wherein the resin is a dual cure resin for producing an object comprising polyurethane, polyurea, or a copolymers thereof; epoxy; cyanate ester; or silicone.

7. A method of making a black-colored object, comprising exposing the resin of claim 1 to temporally and spatially patterned light in a bottom-up or top-down stereolithography apparatus until said object is produced.

8. The method of claim 7, wherein said stereolithography apparatus comprises a bottom-up stereolithography apparatus.

9. The method of claim 7, wherein said method comprises the steps of:
(a) providing an additive manufacturing apparatus including a build platform and a light transmissive window, said build platform and said window defining a build region therebetween, with said window carrying the resin;
(b) advancing said build platform and said window towards one another until said build platform contacts said resin; and
(c) producing a black-colored object by exposing said resin to patterned light through said window and advancing said window and said build platform away from one another while maintaining a sustained liquid interface of unpolymerized resin between said object and said window.

10. The method of claim 9, wherein said sustained liquid interface is maintained by passing an inhibitor of polymerization through said window and into said sustained liquid interface, by exposing said sustained liquid interface to light at a second wavelength that inhibits polymerization thereof, or a combination thereof.

11. The method of claim 7, wherein said patterned light is ultraviolet light.

12. The method of claim 7 wherein the method is carried out by continuous liquid interface production (CLIP).

13. A black-colored object produced by the method of claim 7.

14. The object of claim 13, wherein said object comprises an open lattice portion.

15. The object of claim 13, wherein the object comprises a polymer selected from the group consisting of: polyurethane, polyurea, and copolymers thereof; epoxy; cyanate ester; silicone; and combinations thereof.
